(19) United States
(12) Patent Application Publication
(10) Pub. No.: US 2010/0299559 A1
(43) Pub. Date: Nov. 25, 2010

(54) METHOD FOR PROCESSING THE VOLUME OF INFORMATION HANDLED DURING THE DEBUGGING PHASE OF OPERATIONAL SOFTWARE ONBOARD AN AIRCRAFT AND DEVICE FOR IMPLEMENTING THE SAME

(75) Inventor: Famantanantsoa Randimbivololona, Toulouse (FR)

Correspondence Address: Perman & Green, LLP, 99 Hawley Lane, Stratford, CT, 06614, US

(73) Assignee: AIRBUS OPERATIONS (SOCIETE PAR ACTIONS SIMPLIFIEE), Toulouse (FR)

(21) Appl. No.: 12/678,144

(22) PCT Filed: Sep. 12, 2008
(86) PCT No.: PCT/FR2008/051647

§ 371 Date: Aug. 12, 2010

(30) Foreign Application Priority Data
Sep. 14, 2007 (FR) 0757600

(51) Int. Cl. G06F 11/36; G06F 11/07

(52) U.S. Cl. 714/15; 714/38; 714/E11.023; 714/E11.208

(57) ABSTRACT

A method for processing the volume of information handled during the debugging phase of an operational software onboard an aircraft includes: dividing the execution path of the operational software into functional intervals by placing progression points at each function of the program; placing control points associated with each progression point; normal execution of the program that includes: storing the execution state of the program at the location of each progression point, wherein the storage of an execution state results in the suppression of the execution state previously stored for said progression point; upon the detection of an error, searching the progression point corresponding to a faulty function; searching for a software start execution state; regenerating the start execution state; correcting the error in the faulty function; and re-executing the program.

### CROSS-REFERENCE TO RELATED APPLICATIONS

This application is the National Stage of International Application No. PCT/FR2008/051647 International Filing Date, 12 Sep. 2008, which designated the United States of America, and which International Application was published under PCT Article 21 (s) as WO Publication No. WO 2009/047433 A2 and which claims priority from of French Application No. 200757600 filed on 14 Sep. 2007, the disclosures of which are incorporated herein by reference in their entireties.

### BACKGROUND

The disclosed embodiments relate to a method for processing information handled during the debugging phase of an operational software onboard an aircraft. This method allows a developer to significantly reduce the volume of information, and thus the memory resources, required for researching and correcting errors in onboard operational software.

The disclosed embodiments have particularly advantageous applications, although not exclusively in aeronautics, particularly in testing onboard operational software.

### SUMMARY

For safety reasons, systems designed to be used onboard aircraft are subject to operational testing, during which it must be demonstrated that said systems meet certification requirements before an aircraft equipped with such systems is allowed to fly or, even more, be put into commercial service.

Before installation, these systems undergo extensive testing to verify that they meet the integrity and safety requirements established by certification authorities, among others. Specifically, these onboard systems may be special calculators designed to perform functions that may be important for aircraft, such as functions related to flying. These systems will hereafter be called computers.

Most often, in the architectures of current systems, each computer is dedicated to an application or to multiple applications of the same nature, such as flight command applications. Each computer includes a hardware portion and a software portion. The hardware portion has at least one central processing unit (CPU) and at least one input/output component by which the computer is connected to a computer network, external devices, etc.

An essential characteristic of onboard systems often implemented in aeronautics is related to an architecture, both hardware and software, that prevents any unnecessary means of executing the functions dedicated to such systems, as much as possible.

Thus, unlike systems generally encountered in widespread applications, in aeronautics, the computer is not equipped with a complex operating system. In addition, the software is produced in a language that is as close as possible to the language understood by the central processing unit, and the only available inputs and outputs are those necessary to operating the system, such as information from sensors or other parts of the aircraft or information designed for actuators or other items.

The advantage of this type of architecture is its much greater control over the operation of such a system. It is not dependent on a complex operating system with some aspects of its operation being a function of uncontrolled parameters and otherwise subject to the same safety demonstrations as the application software. The system is simpler and less vulnerable because it only has the absolutely necessary means for executing the functions belonging to that system.

In exchange, it is much more difficult to observe the operation of such a system. For example, the system does not have a traditional human-machine interface, such as a keyboard or screen, which would make it possible to verify that sequences of operations are being performed properly or interact with its performance, making it difficult to carry out the necessary checks during software development and testing.

The computer's software portion includes software that is specific to the considered application and that ensures that the computer operates with logical instructions corresponding to algorithms that define how the system operates.

For the system to be certified prior to being put into service and prior to the aircraft being put into service, the calculator undergoes a testing phase.

In a known manner, the testing phase generally involves verifying compliance, at each step of the computer's processing, with the specifications established so that said calculator satisfies the expected operation of the system.

Particularly for software, this compliance with specifications is achieved in successive steps, from verifying the simplest components of the software to the full software's integration of all components integrated into the target computer.

In the first step, the simplest software elements that can be tested undergo tests, called unit tests. During these tests, it is verified that the software elements' logical instructions, or code, taken individually, have been completed in compliance with the design requirements.

In the second step, called the integration step, various software components, which have individually been tested in isolation, are integrated, forming an assembly in which the software components interact. These various software components undergo integration testing to verify that the software components are compatible, especially at the functional interfaces between said components.

In a third step, the software component assembly is integrated into the computer for which they were designed. Validation testing is then performed in order to demonstrate that the software, formed by the set of components integrated into the computer, complies with the specification, meaning that it performs the expected functions and that its operation is safe and reliable.

To ensure that a software is safe and to satisfy the certification requirements, it is also necessary, during this testing phase, to demonstrate that all of the tests the software undergoes make it possible to conclude, with the proper level of likelihood, that the software complies with the safety requirements for the system in which it is incorporated.

The various tests performed on the software during the testing phase can ensure that failure can occur in said software (that could have an impact on the proper operation of the computers, and consequently on the aircraft and its safety) and that, if a failure were to occur, the software is able to control it.

However, during the testing phase, and especially for investigative operations when anomalies are detected, it is often necessary to ensure not only that the input and output parameters of the computer on which the software is installed comply with expectations, but also that some of the software's internal behavior is correct.

In this case, due to the architecture specific to computers for onboard applications, it is usually very difficult to observe the software's operation without implementing special devices and methods.

A first known method involves setting up a file distribution system between the computer being tested with the software installed and an associated platform, using emulators. Using the emulator, a device can simulate the logical operation of a computer unit, a computer processor, on the associated platform.

In such an operating mode involving an emulator, the computer processor is replaced by a probe that interfaces with the associated platform having the processor emulation.

It is therefore possible for the software being testing to be executed on the computer, excluding the processor and, by functions of the associated platform, to observe the software's operation some of its internal failures, such as in response to simulated inputs to input/output units, observing the outputs of said input/output units.

This first method has many disadvantages. Effectively, each type of computer to be tested requires a specific test bed or at least a very specific configuration for a test bed. A test bed is a set containing, in particular, means for interacting with the computer being tested, means for emulating the computer processor(s), and means for executing test programs.

Because each processor requires a specific emulator, both for the emulation software and for the problem acting in place of the processor, the emulators must be multiplied as defined by the computers.

Additionally, the possibilities for investigating via emulators are generally limited. Also, the need to work with a machine language specific to the given processor means that the developer must be an expert in machine programming.

In addition, an emulator is an expensive product that is typically not produced in large quantities. This type of product has a very short lifespan (6 months to 2 years), while the means for development and testing (regulations, industrial responsiveness) must be kept operational for the duration of the airplane program (20 years or longer). This results in obsolescence-related problems that are increasingly more difficult to resolve.

This emulator solution is therefore not suitable because, in addition to its limited investigative performance, it is expensive to install and expensive to maintain.

The cost is also detrimental due to the fact that different processor models are typically used to ensure functional redundancy as a safety design, multiplying the emulator requirements.

A second method, intended to overcome the problems associated with emulators, involves using a host platform to simulate the computer's operation in executing the program being tested. In this case, the software being tested must access host platform files either to read test vectors or to record test results.

Because the software being tested does not naturally contain functions for accessing the host platforms file system, it is necessary to modify the software being tested in order to include these access functions.

To transfer information, system call instructions are generally used, which are issued by the simulated test environment. The system call instructions may be, for example, instructions to open a file, write a file, or even read a file. System call instructions are intercepted by the host platform's operating system, which converts them into system calls on the host platform.

This second method also has disadvantages. The variety of files is such that developing access functionalities is highly dependent on the host platform and its operating system. Also, there is as much variability of host platforms as space (if there are development teams scattered around the world) and time (replacement of host platforms), which poses practical problems when implementing the method.

These problems are compounded by the fact that experts capable of modifying operating system functions must have the required skills to develop such file system access functionalities, which cannot be entrusted to test specialists.

Consequently, this method is expensive and difficult to implement.

In addition, this method is highly intrusive with respect to the software being tested, and modifying software for testing creates the risk of disturbing the operation of the software itself.

During the computer testing phase, or during tests, there may be an interruption in the execution of the operational software. This interruption occurs as a stoppage in the performance of the operational software or by the fact that the software is stuck in an infinite loop in the code. The developer must then research anomalies or errors in the code in order to correct them. This research is performed through execution, by which successive setpoints in the execution path appear in reverse order with respect to normal execution. In other words, a code sequence possibly containing the error (i.e., an already-executed code sequence containing one or more errors) is begun, and the sequence is re-executed. This research is called reverse execution.

This reverse execution requires that, at every point in the operational software's execution path consisting of a succession of lines of code, the developer understands the progression of the code. However, the developer does not know where the error exists in the execution path. He therefore does not know how many lines of code the reverse execution must include. In addition, for onboard software, the reverse execution must be done in the same language as the normal execution, or machine language. It is therefore difficult for the developer to adequately understand the performance of the operational software program so as to isolate the code sequence and find the error. In addition, there is no way to control or monitor the reverse execution so as to indicate to the developer how far to go in the faulty sequence in order to find the error or anomaly.

Given its complexity, which error search requires considerable time, ranging from a few hours to several days, resulting in a relatively high cost for the debugging phase, in terms of productivity and labor.

In addition, in order to perform a reverse execution of the program, information on the status of the program's execution must first be captured and returned. All of this captured information is stored in a data memory, to be regenerated later. However, the program execution path can be long. There is a considerable volume of handled and stored data, which can pose a problem with regard to the capacity of the memory resource.

Several solutions have been developed to solve the problems outlined above. One solution is to compress all of the handled data. This solution is inefficient because the compression ratio is random (varied based on the different data being handled). Also, it appears that the increased memory space at the end of the compression operation is relatively low for the high cost of data compression.

A second solution involves reducing data by capturing only the data that is strictly necessary. The method used in this second solution is called copy-on-write. This solution is based on a regular verification of the set of information in order to capture only the modified data pages, which makes it possible to have the minimum amount of information for the subsequent regeneration.

Unlike the first solution, the cost of this capture is minimal. However, the regeneration performed requires a relatively long time, especially during interactive debugging, since each reconstitution of an original execution state is established from all of the captured checkpoints, from the start of the program.

The disclosed embodiments aim to remedy the disadvantages described above. For this, the disclosed embodiments provide a method for processing the volume of information handled during the debugging phase of an onboard operational software.

The method of the disclosed embodiments can reduce and optimize the memory resource needs attributable to an onboard system. For this, the method of the disclosed embodiments proposes to divide the operational software's execution path into functional intervals, to capture information related to the state of execution of the software being tested at a given location, and to subsequently return this information.

More specifically, the disclosed embodiments relate to a method for processing the volume of information handled during the debugging phase of an operational software program for an onboard system, wherein it comprises the following steps:

a) dividing the execution path of said operational software into functional intervals by placing progression points at each function of the program,

b) placing checkpoints associated with each progression point,

c) normal execution of the program, which comprises:
the storage of the execution state of the program at the location of each progression point,
the storage of an execution state resulting in the removal of the previously stored execution state for said progression point,
upon the detection of an error:
   searching the progression point corresponding to a faulty function,
   searching for a software start execution state,
   regenerating the start execution state,
   correcting the error in the faulty function, and
   re-executing the program.

The disclosed embodiments can also have one or more of the following characteristics:
a single execution state is stored in a data memory at a time;
after the normal execution of a function, the progression point corresponding to this function changes from an inactive state to an active state;
the search for the faulty function consists of searching for the last active progression point;
a list of progression points with their state is stored;

The disclosed embodiments also relate to a device simulating the operation of a computer onboard an aircraft, wherein it implements the method as defined above.

This device can include a data memory capable of storing the program's execution state.

The disclosed embodiments also relate to an operational software program for an onboard aircraft system, loaded on a control unit with code sequences to implement the method as described above, when the program is loaded on the unit and executed.

The disclosed embodiments will be better understood upon reading the following description and studying the figures that accompany it. They are presented for illustrative purposes and are not limiting to the disclosed embodiments.

### BRIEF DESCRIPTION OF THE DRAWINGS

FIG. 1 illustrates a functional diagram of the method in the disclosed embodiments.

FIGS. 2a and 2b schematically show a device in which the method of the disclosed embodiments is implemented.

### DETAILED DESCRIPTION

Operational software consists of a set of programs. A program consists of a set of written instruction sequences, hereafter called instruction strings. These instruction strings are normally executed in their order of occurrence, that is, from the first instruction to the last instruction. These instruction strings executed in their order of occurrence form the program's normal execution path.

To debug a program effectively, that is, in order to find and correct error, design flaws, and anomalies in how a program operates, the method of the disclosed embodiments suggests positioning tags in the program's execution path so as to be able to determine, based on these tags, where the error or anomaly is located. The tags are virtual markers positioned as specific locations in the program. These locations correspond, for example, to the start or end of the various functions in the program. A function is a sequence of instructions that, as a whole, performs a specific operation. The program's functions are executed one after another. Tags are placed, for example, at each entry point and each exit point within a function in the program. When the tags are placed at the input and output of each program function, they are said to form a functional pass through the program.

Each tag has a progression point and a checkpoint.

The progression point is a virtual marker that can be positioned at specific locations in the program. The locations for the progression points in the program are those described earlier for tags. Progression points are points of reference when the program is executed. Understandably, progression points subsequently form checkpoints in the execution path's progress within the program, located at an interruption in the program's progress in reverse execution (when one or more anomalies or errors have been encountered). Regular distribution of these progression points along the program's execution path makes it easier and faster to search for encountered errors or anomalies. This distribution can be functional, wherein the progression points divide the program's execution path into adjacent functional intervals.

Each tag's control path is a state vector that corresponds to an image of the memory in which the various data used during program execution are recorded. A checkpoint indicates the state of the program's execution at a given location, which is the location of the program where the tag is located, which makes it possible later to reinitialize the memory with the information from the checkpoint. There is a checkpoint associated to each progression point. A checkpoint consists of all of the information referenced by the program's execution between two temporally consecutive tags. This set is therefore the smallest set that is required and sufficient in order for the program to be re-executed between the two tags.

Each progression point can have two states: an active state and an inactive state. In addition to its state (active or inactive), a progression point contains the associated program address along with information that identifies the processing to perform when the program is executed up to the address of the progression point. At the start of the program, all of the progression points are inactive. All of the checkpoints corresponding to the progression points are neutral, meaning that they do not contain any information.

Each time a function is executed normally, the progression point located at the end of the function, or at the start of the next function, changes to an active status. The checkpoint associated to this progression point then captures or stores the execution state of the program at the location of the progression point.

During the normal execution of the program, the progression point located after a normally executed function (at the end of the function or at the start of the next function) changes from an inactive state to an active state. When a progression point changes to an active status, the program's execution state is captured by the checkpoint corresponding to this progression point. In other words, the program's execution point at a given location of the program is stored in a data memory.

According to the disclosed embodiments, the program's various execution states are saved successively, one after the one in a single data memory so that the same execution state is stored simultaneously in the data memory. The stored execution state is the last execution state captured, which is the program's execution state at the location of the last active progression point. In the disclosed embodiments, only the saving of this latest execution state is considered to be required in order to later regenerate the program's execution state, when in reverse execution. In one embodiment, capturing an execution state deletes the record of the previous execution state. In another embodiment, after each recorded execution state, the previously saved execution state is deleted such that the data memory contains only one execution state, namely the execution state used in order to step through the program during the reverse execution.

When an error occurs, the developer performs a reverse execution of the program in order to find said error within the program. This reverse execution makes it possible to run the program in reverse of the program's normal progression in order to step through its execution at the first line of code in the function corresponding to the last active progression point, which is the last function whose checkpoint captured information on the state of the program.

A list of progression points is stored with the state at each of these points. Thus, when the program's execution is interrupted, the last active progression point is found, and the program's location is set to this progression point. It then searches in the data memory for the saved execution state and re-executes the program from that location, using the data related to the saved execution state.

This, according to the disclosed embodiments, the reverse execution is carried out by following the progression points to step through the program's instruction string and identify the location of the faulty instruction string. The reverse execution can thus be carried out within a single functional interval. When a faulty string, or error, is detected in this functional interval, the developer researches the error or anomaly in the string and then corrects it.

Using the checkpoints, the program can be re-executed from the location of the last active progression point. Stepping through the program requires the starting execution state to be retrieved. According to the disclosed embodiments, this retrieval and the execution state require only, as memory space, the place corresponding to an execution state. In addition, the link between the progression point and the checkpoint make it possible to quickly retrieve the starting execution state.

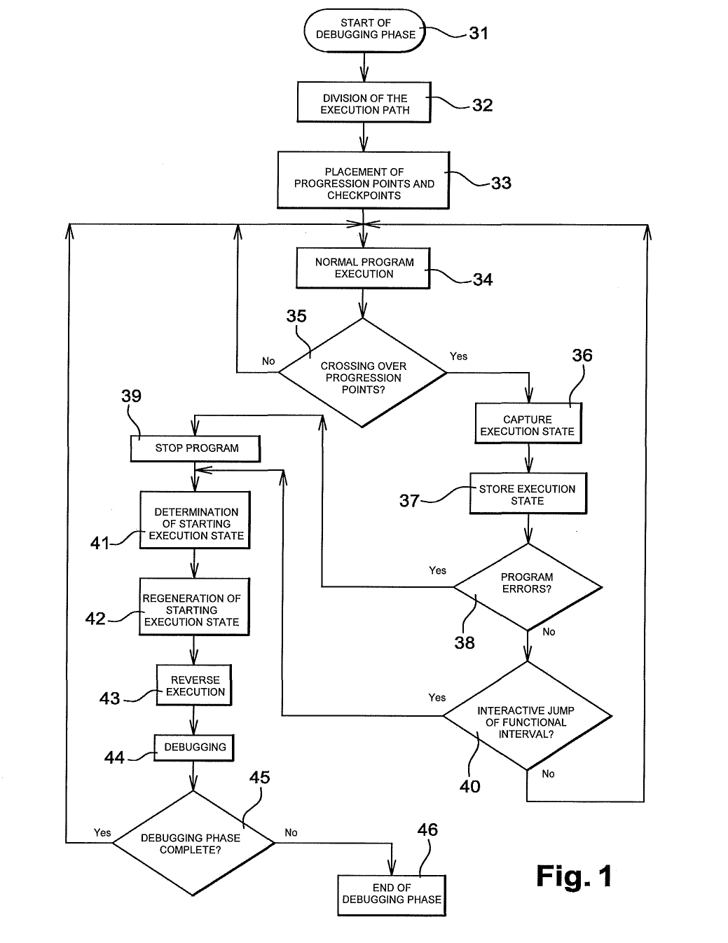

FIG. 1 is an example functional diagram of the method in the disclosed embodiments. This method includes a preliminary step 31 for initializing a debugging phase. This step reinitializes the different parameters used in the proper performance of the debugging phase.

In Step 32, an even and appropriate division is made in the operational software program's execution path. This division makes it possible to identify the operational context associated with any interval in the program's execution path.

At Step 33, the progression points along the program's execution path are distributed so as to divide said execution path into functional intervals. Each progression point is associated with a checkpoint. All of the checkpoints and progression points form a tag. Each progression point has a passive role; it is merely an indicator that shows the step points in the execution of the program. The checkpoint has an active role, meaning that it can have two different states (active or inactive). The checkpoint's role is to capture execution state information at a specific location in the program and at a specified time.

At Step 34, the program executes normally. A test loop is applied to the program as Step 35. At this Step 35, passages are detected on a progression point. If a passage on a progression point is detected during the program's execution, meaning that a progression point has been crossed, Step 36 is applied. Otherwise, Step 34 is repeated.

In Step 36, the program's execution state is captured at a given location. This captured program execution state is stored in Step 37.

Step 38 is a step for detecting an error in the program. If an error is detected in the program, then Step 39 is applied. Otherwise, Step 40 applies.

At Step 39, the program's execution stops. Then, in Step 41, the program's starting execution state is determined. This starting execution state is the last execution state recorded in the data memory during Step 37.

In Step 42, the starting execution state is regenerated, being the program's execution state at the end of the last function executed without an error. Regenerating the starting execution state makes it possible to return the context of the functional interval for the execution path.

In Step 43, a reverse execution is carried out, in which the program is re-executed from the last active progression point, considering, as an execution state, the one captured by the checkpoint associated with the active progression point.

In Step 44, the root cause of the error in the faulty function is researched in order to step through the faulty string and then correct the error in the program.

In Step 45, it is verified that the debugging phase has ended. If the debugging phase has ended, then the program can be executed in its entirety (Step 46). Otherwise, it returns to Step 34 and re-executes Steps 34 to 45.

When there are no errors in the program (Step 38), Step 40 is applied. In Step 40, it is determined whether the developer has interactively requested a jump in the functional interval. If a jump in the functional interval has been requested, Step 41 and subsequent steps are applied. Otherwise, Step 34 is applied again, making it possible to continue the program's execution. In the disclosed embodiments, passing through the program can be done automatically, meaning that the developer chooses to position additional tags within a single function. These additional tags may be entry tags, exit tags, and/or intermediary tags. The choice as to whether to pass through interactively or automatically is made by the developer himself. An interactive pass-through makes it possible to refine the search interval and correct an error, which can reduce said interval and thus make it easier to detect the error.

From the above, it is understood that the method in the disclosed embodiments makes it possible to debug using a small volume of information, compared to known methods, because the data that is captured and then retrieved through checkpoints and progression points are only those corresponding to a single execution state. The program has a low volume of execution state information. In addition, the cost of such a regeneration is not dependent on the position of the program's starting execution state to be regenerated or on the size of the data memory 4.

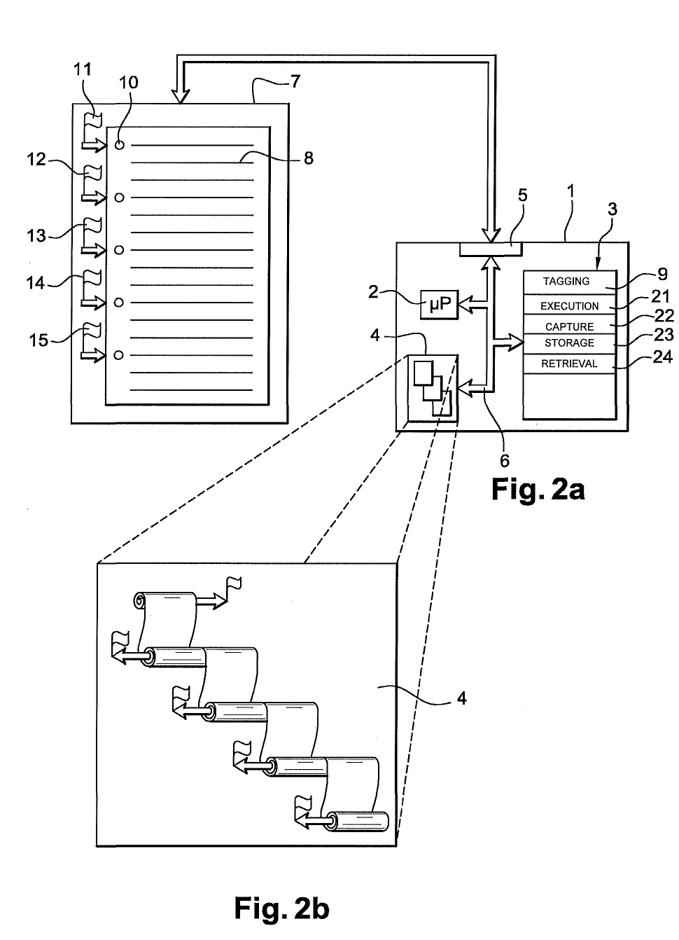

FIG. 2a shows an example of a command unit 1 for a test environment for an operational software onboard an aircraft. According to embodiments, the test environment can be either virtually simulated on a host platform or based on emulator hardware.

The command unit 1 includes, but is not limited to, a processor 2, a program memory 3, a data memory 4, and an input/output interface 5. The processor 2, the program memory 3, the data memory 4, and the input/output interface 5 are connected to one another by a bidirectional communication bus 6.

In FIG. 2a, an operational software program 7 is represented schematically, during a debugging phase. The program 7 includes an execution path 8. The execution path 8 has a set of lines of instructional code. The execution path 8 is divided evenly and appropriately in order to form functional intervals. During the debugging phase, the program 7 is therefore constantly connected with the processor 2, the program memory 3, and the data memory 4.

In a zone 9, the program memory 3 includes instructions for tagging the program 7. Tagging the program 7 makes it possible to set progression points 10 along the execution path 8. Each progression point 10 is associated with a functional interval. Tagging the program 7 can also set checkpoints 11, 12, 13, 14, and 15, with regard to the respective progression points 10. In a zone 21, the program memory 3 includes instructions for executing the program 7. The program execution 7 steps through the execution path 8, instruction by instruction. Stepping through the execution path of the program 7 validates the movement along the progression points 10. Crossing over progression points sequentially activates the checkpoints 11, 12, 13, 14, and 15. The program memory 3 includes, in a zone 22, the instructions for capturing information on the starting execution state for the program 7. Activating the checkpoints 11, 12, 13, 14, and 15 sequentially captures the starting execution states of the program 7. The program memory 3 includes, in a zone 23, the instructions for storing information on the starting execution state for the program 7. This information is stored in the data memory 4. The program memory 3 includes, in a zone 24, the instructions for retrieving information on stored execution states. In FIG. 2b, more detail is shown on the data memory 4.

1. A method for processing the volume of information handled during the debugging phase of an operational software program for an onboard system, comprising:
dividing an execution path of said operational software into functional intervals by placing progression points at each function of the program,
placing checkpoints associated with each progression point,
normally executing the program, which comprises:
storing the execution state of the program at the location of each progression point,
storing an execution state resulting in the removal of the previously stored execution state for said progression point,
upon a detection of an error:
searching the progression point corresponding to a faulty function,
searching for a software start execution state,
regenerating the start execution state,
correcting the error in the faulty function, and
re-executing the program.

2. A method according to claim 1, comprising storing a single execution state in a data memory at a time.

3. A method according to claim 1, wherein, after the normal execution of a function, the progression point corresponding to the function changes from an inactive state to an active state.

4. A method according to claim 3, wherein the search for the faulty function comprises searching for the last active progression point.

5. A method according to claim 3, wherein a list of progression points with their state is stored.

6. A device simulating the operation of a computer onboard an aircraft, configured to implement the method according to claim 1.

7. A device according to claim 6, comprising a data memory capable of storing the program's execution state.

8. An operational software program for an onboard aircraft system, loaded on a control unit with code sequences to implement the method according to claim 1, when the program is loaded on the unit and executed.
